(19) United States
(12) Patent Application Publication
(10) Pub. No.: US 2020/0194003 A1
(43) Pub. Date: Jun. 18, 2020

(54) MEETING MINUTE OUTPUT APPARATUS, AND CONTROL PROGRAM OF MEETING MINUTE OUTPUT APPARATUS

(71) Applicant: KONICA MINOLTA, INC., Tokyo (JP)

(72) Inventor: Misaki FUNATO, Tokyo (JP)

(73) Assignee: KONICA MINOLTA, INC., Tokyo (JP)

(21) Appl. No.: 16/687,780

(22) Filed: Nov. 19, 2019

(30) Foreign Application Priority Data
Dec. 14, 2018 (JP) 2018-234375

(51) Int. Cl. G10L 17/00; G10L 17/02

(52) U.S. Cl. CPC G10L 17/005; H04L 65/4053; G10L 17/02

(57) ABSTRACT

A meeting minute output apparatus includes a hardware processor. The hardware processor acquires information regarding a number of participants at a meeting. The hardware processor acquires data regarding speech at the meeting. The hardware processor recognizes the speech on a basis of the data regarding speech and converts the speech into text statements of speakers. The hardware processor distinguishes the speakers on a basis of the information regarding the number of participants and the data regarding speech. The hardware processor causes an output to output meeting minutes in which labels indicating the speakers are associated with content of the statements converted into text.

### CROSS-REFERENCE TO RELATED APPLICATION

Japanese patent application No. 2018-234375 filed on Dec. 14, 2018, including description, claims, drawings, and abstract the entire disclosure is incorporated herein by reference in its entirety.

### BACKGROUND

### 1. Technological Field

The present invention relates to a meeting minute output apparatus, and a control program of the meeting minute output apparatus.

### 2. Description of the Related art

Various kinds of techniques of distinguishing speakers are known in related art. For example, Japanese Patent Application Laid-Open No. 2009-109712 discloses a technique of distinguishing speakers by segmenting speech data and determining whether or not each segment belongs to a model of a speaker.

SUMMARY

However, because the technique disclosed in Japanese Patent Application Laid-Open No. 2009-109712 is not used especially for a meeting in which a plurality of persons take part, there is a problem that accuracy of distinguishing speakers at a meeting in which a plurality of persons take part cannot be improved. Further, while there is a case where it is necessary to convert content of a statement of each speaker into text to output meeting minutes at a meeting in which a plurality of persons take part, with the technique disclosed in Japanese Patent Application Laid-Open No. 2009-109712, such meeting minutes are not output.

The present invention has been made in view of the above-described problem. It is therefore an object of the present invention to provide a meeting minute output apparatus which outputs meeting minutes in which speakers at the meeting are distinguished with high accuracy, and a control program of the meeting minute output apparatus.

To achieve at least one of the abovementioned objects, according to an aspect of the present invention, a meeting minute output apparatus reflecting one aspect of the present invention comprises a hardware processor that: acquires information regarding a number of participants at a meeting; acquires data regarding speech at the meeting; recognizes the speech on a basis of the data regarding speech and converts the speech into text statements of speakers; distinguishes the speakers on a basis of the information regarding the number of participants and the data regarding speech; and causes an output to output meeting minutes in which labels indicating the speakers are associated with content of the statements converted into text.

To achieve at least one of the abovementioned objects, according to an aspect of the present invention, a non-transitory recording medium reflecting one aspect of the present invention stores a computer readable program which is a control program of a meeting minute output apparatus which outputs meeting minutes, the control program causing a computer to perform: acquiring information regarding a number of participants at a meeting; acquiring data regarding speech at the meeting; recognizing the speech on a basis of the data regarding speech and converting the speech into text as statements of speakers; distinguishing the speakers on a basis of the information regarding the number of participants and the data regarding speech; and causing an output to output meeting minutes in which labels of the distinguished speakers are associated with content of the statements converted into text.

The objects, features, and characteristics of this invention other than those set forth above will become apparent from the description given herein below with reference to preferred embodiments illustrated in the accompanying drawings.

### BRIEF DESCRIPTION OF THE DRAWING

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a block diagram illustrating a schematic configuration of a user terminal according to an embodiment of the present invention;

FIG. 2 is a block diagram illustrating a functional configuration of a controller;

FIG. 3A is a flowchart illustrating procedure of processing of the user terminal;

FIG. 3B is a flowchart illustrating procedure of processing of the user terminal;

FIG. 4A is a view illustrating an example of a screen to be displayed at the user terminal;

FIG. 4B is a view illustrating an example of a screen to be displayed at the user terminal;

FIG. 4C is a view illustrating an example of a screen to be displayed at the user terminal;

FIG. 4D is a view illustrating an example of a screen to be displayed at the user terminal;

FIG. 4E is a view illustrating an example of a screen to be displayed at the user terminal;

FIG. 4F is a view illustrating an example of a screen to be displayed at the user terminal;

FIG. 4G is a view illustrating an example of a screen to be displayed at the user terminal;

FIG. 4H is a view illustrating an example of a screen to be displayed at the user terminal;

FIG. 4I is a view illustrating an example of a screen to be displayed at the user terminal;

FIG. 5 is a flowchart of sub-routine illustrating procedure of speaker distinguishing processing in step S107 in FIG. 3A;

FIG. 6A is a view illustrating an example of a frequency spectrum of speech;

FIG. 6B is a view illustrating an example of a frequency spectrum of speech;

FIG. 7A is a view illustrating an example of clustering of feature amounts of speech;

FIG. 7B is a view illustrating an example of clustering of feature amounts of speech;

FIG. 7C is a view illustrating an example of clustering of feature amounts of speech;

FIG. 8A is a view illustrating an example of a screen to be displayed at the user terminal;

FIG. 8B is a view illustrating an example of a screen to be displayed at the user terminal;

FIG. 8C is a view illustrating an example of a screen to be displayed at the user terminal; and

FIG. 9 is a view illustrating an overall configuration of a meeting minute output system.

### DETAILED DESCRIPTION OF EMBODIMENTS

Hereinafter, one or more embodiments of the present invention will be described with reference to the drawings. However, the scope of the invention is not limited to the disclosed embodiments.

An embodiment of the present invention will be described below with reference to the accompanying drawings. Note that, in the description of the drawings, the same elements are denoted by the same reference numerals, and redundant description is omitted. In addition, in some cases, dimensional ratios in the drawings are exaggerated and different from actual ratios for convenience of the description.

A user terminal as a meeting minute output (creating) apparatus according to an embodiment of the present invention will be described first.

FIG. 1 is a block diagram illustrating a schematic configuration of the user terminal according to an embodiment of the present invention.

As illustrated in FIG. 1, a user terminal 10 includes a controller 11, a storage 12, a communicator 13, a display 14, an operation acceptor 15, and a speech input 16. The respective components are connected to each other via a bus so as to be able to perform communication with each other. The user terminal 10 is, for example, a laptop type or a desktop type PC terminal, a tablet terminal, a smartphone, a mobile phone, or the like.

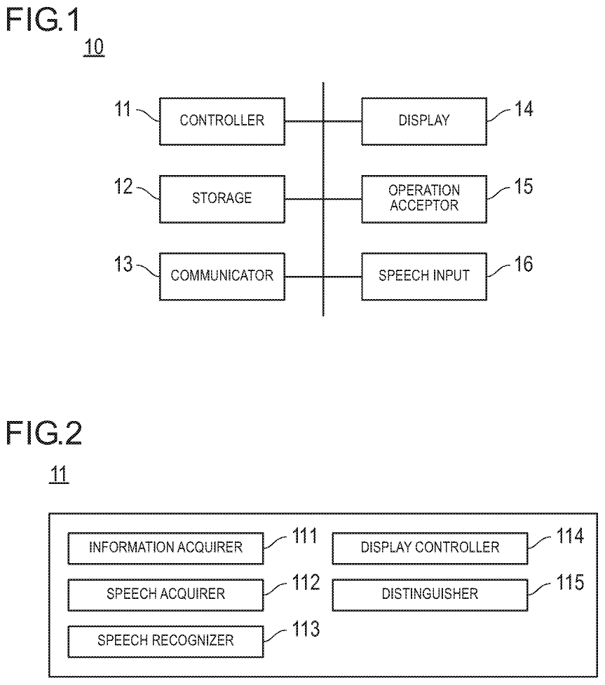

The controller 11 includes a CPU (Central Processing Unit) (a hardware processor), and executes control of the respective components described above and various kinds of operation processing in accordance with the program. A functional configuration of the controller 11 will be described later with reference to FIG. 2.

The storage 12 includes a ROM (Read Only Memory) which stores various kinds of programs and various kinds of data in advance, a RAM (Random Access Memory) which temporarily stores a program and data as a work area, a hard disk which stores various kinds of programs and various kinds of data, or the like.

The communicator 13 includes an interface for performing communication with other terminals, apparatuses, or the like.

The display 14 as an output includes an LCD (Liquid Crystal Display), an organic EL display, or the like, and displays (outputs) various kinds of information.

The operation acceptor 15 includes a keyboard, a pointing device such as a mouse, a touch sensor, or the like, and accepts various kinds of operation of a user. The operation acceptor 15, for example, accepts input operation of the user with respect to a screen displayed at the display 14.

The speech input 16 includes a microphone, or the like, and accepts input of sound such as an outside speech. Note that the speech input 16 does not have to include a microphone itself, and may include an input circuit for accepting input of sound via an external microphone, or the like.

Note that the user terminal 10 may include components other than the above-described components and does not have to include part of components among the above-described components.

Subsequently, the functional configuration of the controller 11 will be described.

FIG. 2 is a block diagram illustrating the functional configuration of the controller.

The controller 11 functions as an information acquirer 111, a speech acquirer 112, a speech recognizer 113, a display controller 114, and a distinguisher 115 as illustrated in FIG. 2 by reading a program to execute processing. The information acquirer 111 acquires various kinds of information. A speech acquirer 112 acquires speech data. The speech recognizer 113 recognizes speech on the basis of speech data using a well-known speech recognition technique and converts the recognized speech into text. The display controller 114 as an output controller controls the display 14 to cause the display 14 to display various kinds of screens. The distinguisher 115 distinguishes speakers on the basis of speech data.

Subsequently, flow of processing at the user terminal 10 will be described. In the processing at the user terminal 10, control is performed so that meeting minutes in which speakers at a meeting are distinguished with high accuracy are output.

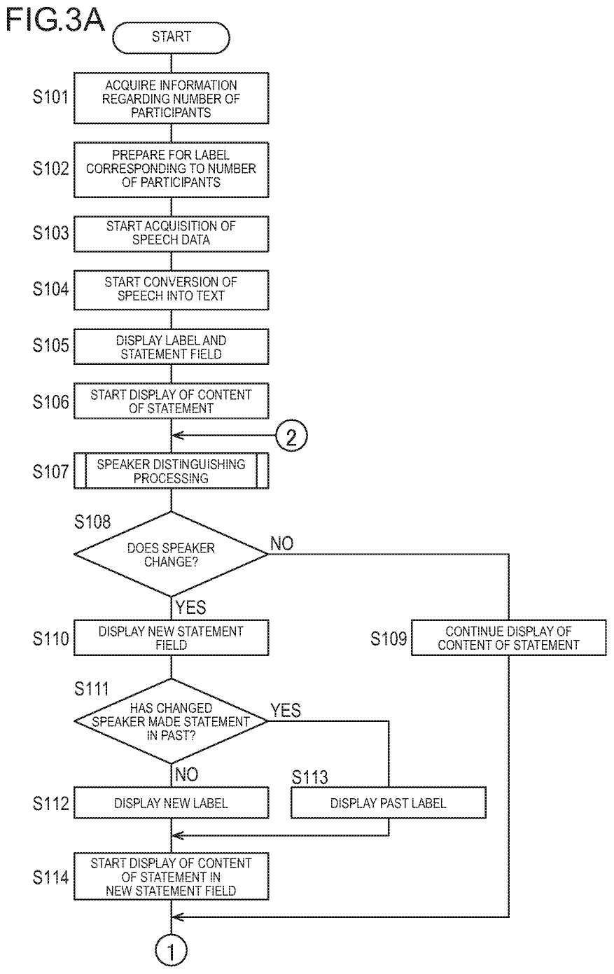

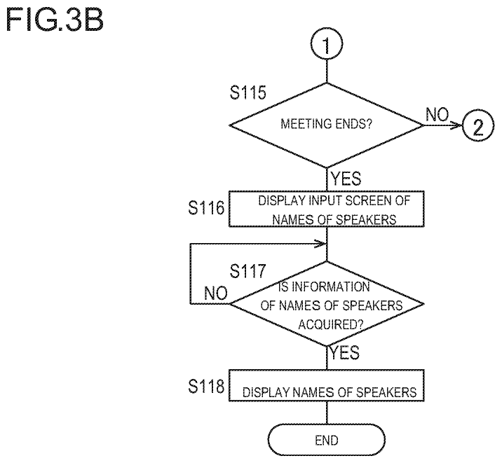

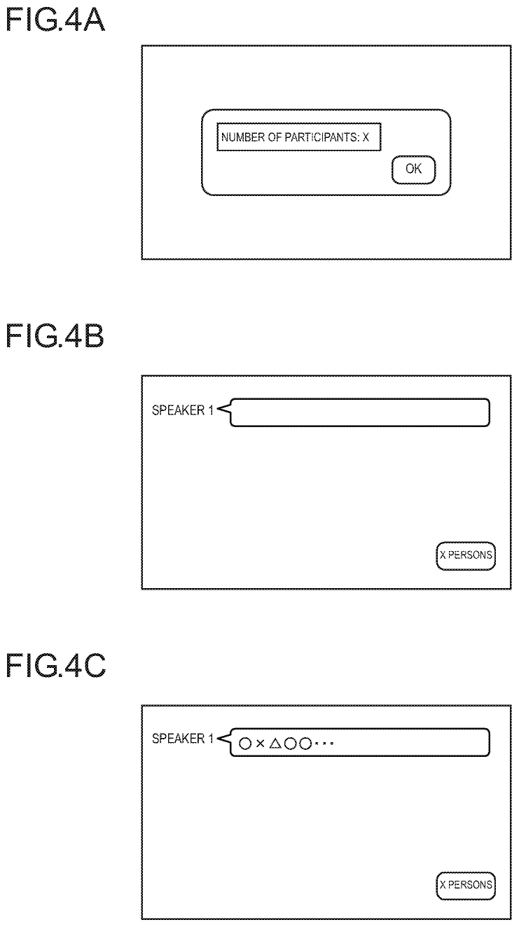

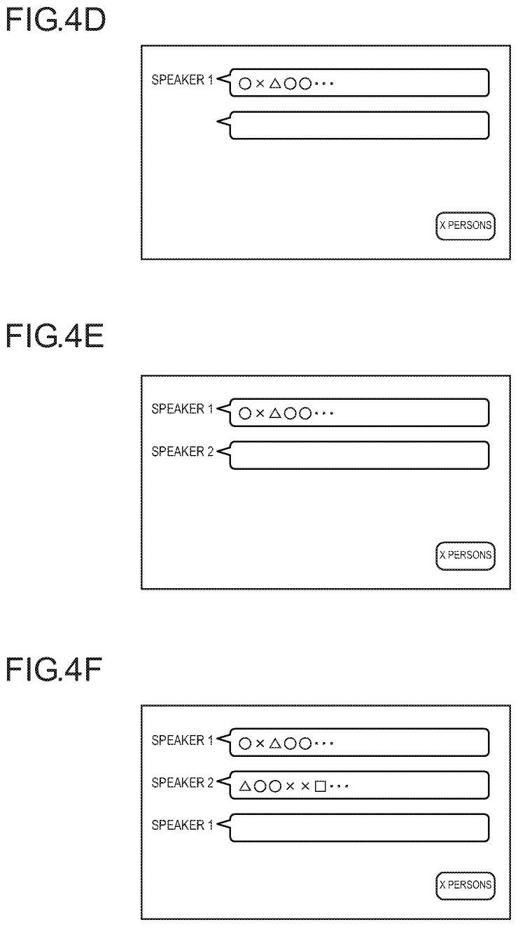

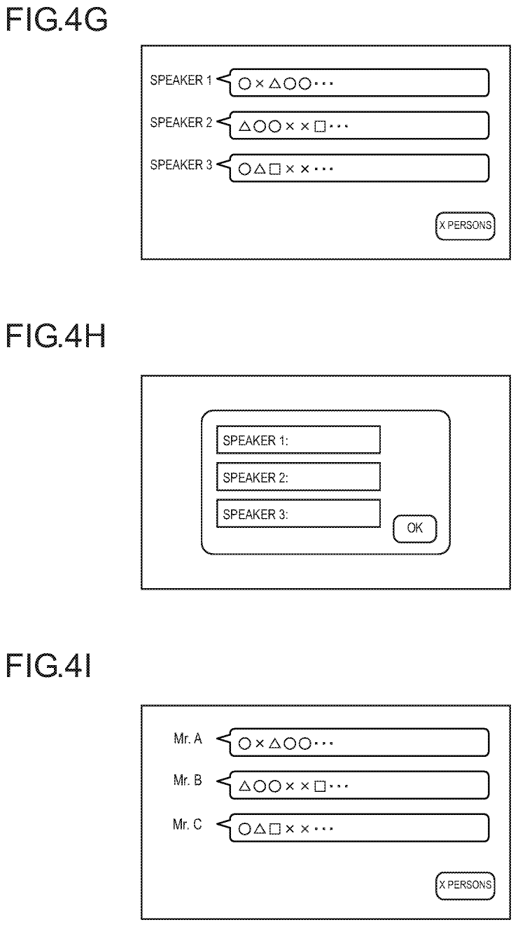

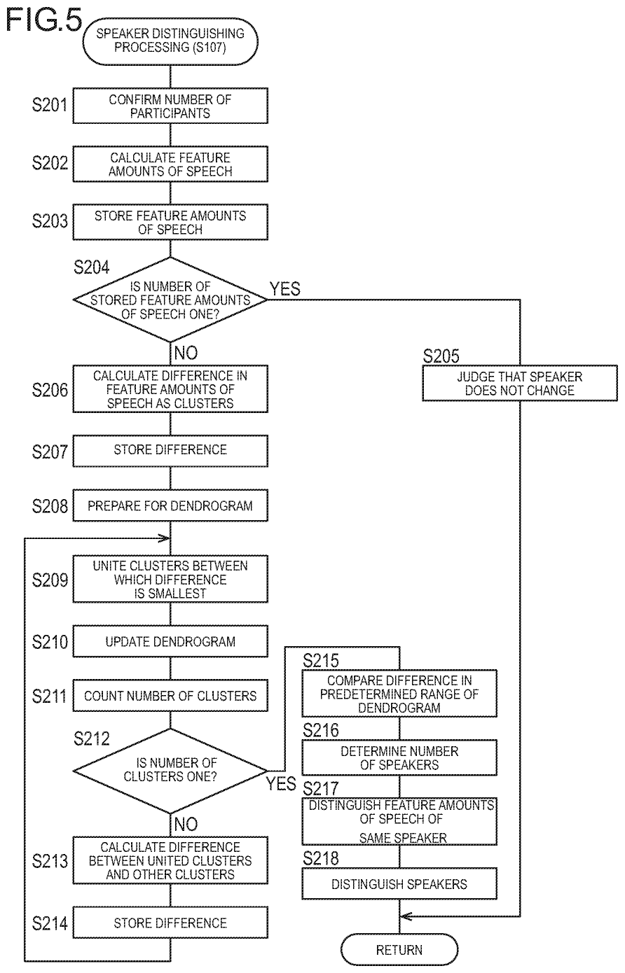

FIG. 3A and FIG. 3B are flowcharts illustrating procedure of the processing at the user terminal. FIG. 4A to FIG. 4I are views illustrating an example of a screen to be displayed at the user terminal. Algorithm of the processing illustrated in FIG. 3A and FIG. 3B is stored in the storage 12 as a program, and is executed by the controller 11.

As illustrated in FIG. 3A, first, the controller 11 acquires information regarding the number of participants at a meeting as the information acquirer 111 before the meeting is started (step S101). More specifically, the controller 11, for example, causes the display 14 to display an input screen of the number of participants as illustrated in FIG. 4A in advance. Then, in a case where the operation acceptor 15 accepts user operation of inputting the number of participants on the input screen, the controller 11 acquires information regarding the number of participants input by the user.

Subsequently, the controller 11 prepares for labels of the number corresponding to the number of participants on the basis of the information regarding the number of participants acquired in step S101 (step S102). The controller 11 then starts processing of acquiring data regarding speech at the started meeting as the speech acquirer 112 (step S103). The controller 11, for example, acquires the data regarding the speech input at the speech input 16. Further, as the speech recognizer 113, the controller 11 recognizes the speech and starts processing of converting the speech into text as a statement of a speaker, on the basis of the data regarding the speech for which acquisition is started in step S103 (step S104).

Further, as the display controller 114, the controller 11 causes the display 14 to display a label indicating an initial speaker and a statement field indicating an initial statement in association with each other (step S105). The processing in step S105 may be executed in parallel during execution of the processing in step(s) S103 and/or S104. The display 14 displays the label of “speaker 1” indicating the initial speaker and a speech balloon as the statement field indicating the initial statement in association with each other, for example, as illustrated in FIG. 4B. Note that the controller 11 may further cause the display 14 to display a current number of participants on the basis of the information regarding the number of participants acquired in step S101, for example, as illustrated in FIG. 4B.

Subsequently, as the display controller 114 the controller 11 starts processing of causing the display 14 to display the label and the statement field displayed in step S105, and content of the statement for which conversion into text is started in step S104 in association with each other (step S106). By this means, the display 14 adds the content of the statement converted into text, to the speech balloon as the statement field with which the label of “speaker 1” is associated, for example, as illustrated in FIG. 4C.

Subsequently, the controller 11 executes speaker distinguishing processing as the distinguisher 115 (step S107). The processing in step S107 is processing of distinguishing speakers on the basis of the information regarding the number of participants acquired in step S101 and the data regarding the speech for which acquisition is started in step S103. Details of the processing in step S107 will be described later with reference to FIG. 5.

Subsequently, as the distinguisher 115, the controller 11 judges whether or not the speaker changes on the basis of a distinguished result in step S107 (step S108).

In a case where it is judged that the speaker does not change (step S108: No), the processing of the controller 11 proceeds to processing in step S109. The controller 11 then continues processing of displaying the content of the statement which is started in step S106 as the display controller 114 (step S109).

In a case where it is judged that the speaker changes (step S108: Yes), the processing of the controller 11 proceeds to processing in step S110. As the display controller 114, the controller 11 then finishes processing of displaying the content of the statement by the speaker before change and causes the display 14 to display a statement field indicating a new statement by the changed speaker (step S110).

Subsequently, as the distinguisher 115, the controller 11 judges whether or not the changed speaker judged in step S108 has made a statement in the past at the meeting (step S111). Note that, in a case where the controller 11 executes the processing in step S111 the first time, a judgement result in step S111 is always No.

In a case where it is judged that the changed speaker has not made a statement in the past (step S111: No), the processing of the controller 11 proceeds to processing in step S112. As the display controller 114, the controller 11 then causes the display 14 to display a label indicating a new speaker in association with the statement field displayed in step S110 (step S112). The display 14 displays a label of “speaker 2” indicating a new speaker in association with a speech balloon as a statement field indicating a new statement, for example, as illustrated in FIG. 4E.

In a case where it is judged that the changed speaker has made a statement in the past (step S111: Yes), the processing of the controller 11 proceeds to processing in step S113. As the display controller 114, the controller 11 then causes the display 14 to display a label indicating a corresponding past speaker in association with the statement field displayed in step S110 (step S113). The display 14 displays a label of “speaker 1” indicating a corresponding past speaker in association with a speech balloon as a statement field indicating a new statement, for example, as illustrated in FIG. 4F.

Subsequently, as the display controller 114, the controller 11 starts processing of causing the display 14 to display the statement field displayed in step S110, the label displayed in step S112 or S113, and content of the statement converted into text in association with each other (step S114). By this means, the display 14 adds the content of the statement to the statement field with which the label indicating a new speaker or a past speaker is associated.

Subsequently, as illustrated in FIG. 3B, the controller 11 judges whether or not the meeting ends (step S115). More specifically, the controller 11, for example, causes the display 14 to display a soft key, or the like, indicating end of the meeting in advance. The controller 11 then judges whether or not the meeting ends by judging whether or not the operation acceptor 15 accepts user operation of depressing the soft key.

In a case where it is judged that the meeting does not end (step S115: No), the processing of the controller 11 returns to the processing in step S107. The controller 11 then repeats processing in steps S107 to S115 until it is judged that the meeting ends.

In a case where it is judged that the meeting ends (step S115: Yes), the processing of the controller 11 proceeds to processing in step S116. In this event, the controller 11 may end processing of acquiring the data regarding the speech which is started in step S103 or processing of converting speech into text which is started in step S104. At this time point, the display 14 can output meeting minutes in which speakers at the meeting are automatically distinguished with high accuracy, for example, as illustrated in FIG. 4G.

Subsequently, as the display controller 114, the controller 11 causes the display 14 to display an input screen for inputting names of speakers corresponding to the labels displayed in step S105, S112, and S113 (step S116). The display 14 displays the input screen of the names of the speakers, for example, as illustrated in FIG. 4H. Note that the display 14 may display the input screen of the names of the speakers as illustrated in FIG. 4H while displaying the meeting minutes as illustrated in FIG. 4G. In this case, the user can consider names of the speakers to be input while confirming content of the statements in the meeting minutes.

Subsequently, as the information acquirer 111, the controller 11 judges whether or not information regarding the names of the speakers corresponding to the labels is acquired (step S117). More specifically, in a case where the operation acceptor 15 accepts user operation of inputting the names of the speakers with respect to the input screen displayed in step S116, the controller 11 acquires information regarding the names of the speakers input by the user.

In a case where it is judged that the information regarding the name of the speakers is not acquired (step S117: No), the controller 11 waits until the information regarding the name of the speakers is acquired.

In a case where it is judged that the information regarding the name of the speakers is acquired (step S117: Yes), the processing of the controller 11 proceeds to processing in step S118. As the display controller 114, the controller 11 then causes the display 14 to display the name of the speakers indicated by the information acquired in step S117 in place of the displayed labels (step S118). Note that, in a case where a plurality of the same labels are included in the meeting minutes (that is, in a case where the same speaker has made statements a plurality of times at the meeting), the controller 11 causes the display 14 to display the same name of the speaker in place of all the same labels. By this means, the display 14 can output final meeting minutes in which the speakers at the meeting are automatically distinguished with higher accuracy, and the names of the speakers are clearly described, for example, as illustrated in FIG. 4I. Thereafter, the controller 11 ends the processing.

Note that, in a case where a predetermined timeout period has elapsed without the information regarding the name of the speakers being acquired in step S117, the controller 11 may end the processing. In this case, the display 14 may output the meeting minutes as illustrated in FIG. 4G as final meeting minutes.

Subsequently, details of the speaker distinguishing processing in step S107 will be described. As described above, the controller 11 repeats processing in steps S107 to S115 until it is judged that the meeting ends. Therefore, the controller 11 executes the processing in step S107, for example, for each predetermined time period.

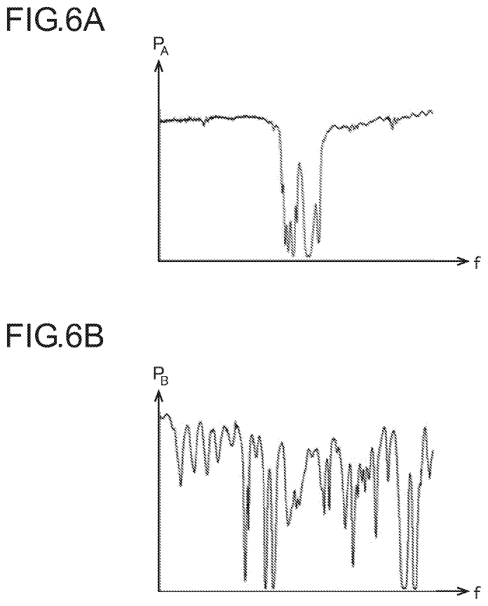

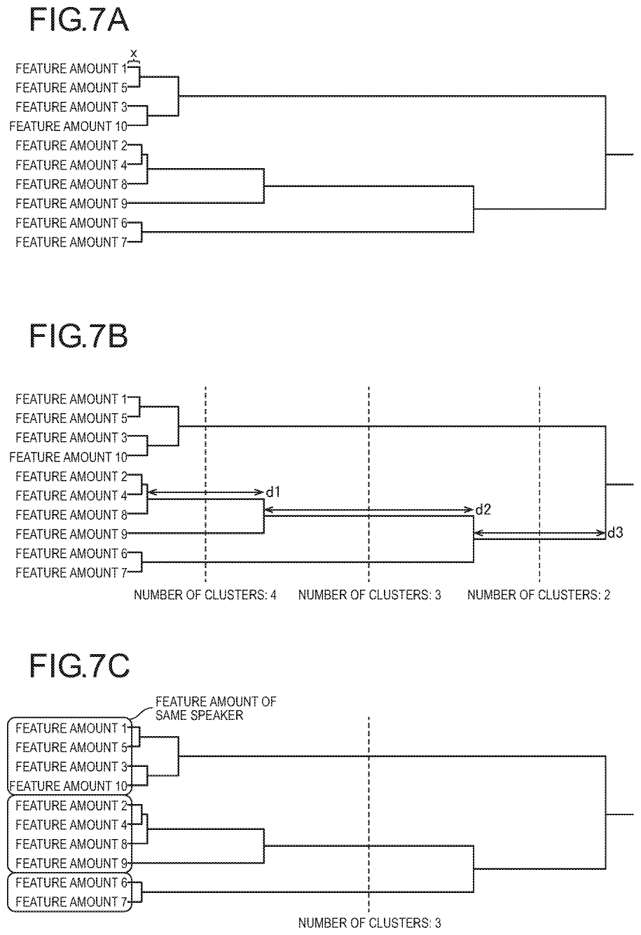

FIG. 5 is a flowchart of sub-routine illustrating procedure of the speaker distinguishing processing in step S107 in FIG. 3A. FIG. 6A and FIG. 6B are views illustrating an example of a frequency spectrum of speech. FIG. 7A to FIG. 7C are views illustrating an example of clustering of feature amounts of speech.

As illustrated in FIG. 5, first, the controller 11 confirms the number of participants indicated by the information regarding the number of participants acquired in step S101 (step S201). The controller 11 then calculates a feature amount of the speech on the basis of data regarding the speech for which acquisition is started in step S103 (step S202). The controller 11, for example, calculates MFCC (Mel-Frequency Cepstrum Coefficients), a formant frequency, or the like, as the feature amount of the speech. Alternatively, the controller 11 may calculate frequency spectrums (amplitude spectrums) P_{A} and P_{B} of the speech, for example, as illustrated in FIG. 6A and FIG. 6B, a voiceprint indicated in a spectrogram, or the like, as the feature amount of the speech. The graphs illustrated in FIG. 6A and FIG. 6B indicate a frequency on a horizontal axis f, and indicate an amplitude on a vertical axis P. Note that the controller 11 may calculate a phase spectrum as the frequency spectrum. The controller 11 then causes the storage 12 to store the feature amount of the speech calculated in step S202 (step S203).

Subsequently, the controller 11 judges whether or not the number of feature amounts of the speech stored in the storage 12 is one (step S204). In a case where the controller 11 executes the processing in steps S201 to S204 the first time, a judgment result in step S204 is always Yes.

In a case where it is judged that the number of the stored feature amounts of the speech is one (step S204: Yes), the controller 11 judges that the number of feature amounts of the speech sufficient for executing clustering processing which will be described later is not stored. In this case, the controller 11 judges that the speaker does not change (step S205), and the processing returns to the processing in FIG. 3A.

In a case where it is judged that the number of the stored feature amounts of the speech is not one, that is, equal to or larger than two (step S204: No), the controller 11 performs well-known cluster analysis on a plurality of feature amounts of the speech, and classifies the feature amounts of the speech as clusters to create a dendrogram as illustrated in, for example, FIG. 7A. In the dendrogram illustrated in FIG. 7A, a length of a horizontal line (for example, a length x) indicates a magnitude of a difference between the feature amounts of the speech as clusters, and a longer horizontal line indicates a larger difference. Further, the difference between the clusters is an index having correlation relationship with similarity between the clusters. More specifically, the difference and the similarity between the clusters have correlation relationship such that, in a case where the difference between the clusters is smaller, the similarity between the clusters is higher. The difference between the clusters may be, for example, a value defined as an inverse of the similarity between the clusters.

More specifically, the controller 11 first calculates the difference (distance) between the clusters assuming that the plurality of stored feature amounts of the speech are respectively clusters (step S206). The controller 11 calculates the difference between the clusters for all pairs of the plurality of clusters. The controller 11, for example, calculates a difference between the MFCC as the difference between the clusters in a case where the MFCC are calculated as the feature amounts of the speech, in step S202. Alternatively, the controller 11 may calculate a difference between frequency spectrums of the speech as the difference between the clusters in a case where the frequency spectrums of the speech are calculated as the feature amounts of the speech, in step S202. The controller 11 may calculate a difference between the frequency spectrums P_{A} and P_{B} of the speech on the basis of the following equation in a case where the frequency spectrums P_{A} and P_{B} of the speech as illustrated in FIG. 6A and FIG. 6B are calculated.

Difference=∫^{MAX}_{∫=0}|P_{A}(ƒ)−P_{B}(ƒ)| [Equation 1]

Subsequently, the controller 11 causes the storage 12 to store the difference calculated in step S206 (step S207). The controller 11 then prepares for a template of the dendrogram (step S208).

Subsequently, the controller 11 unites (performs clustering on) clusters between which the stored difference is the smallest (that is, similarity is the highest) as a new cluster (step S209). The controller 11 then updates the dendrogram by expressing the clusters united in step S209 on the dendrogram stored in step S208 (step S210). For example, when the dendrogram illustrated in FIG. 7A is created, among the stored ten feature amounts of the speech, feature amounts 1 and 5 of the speech which are clusters between which a difference is the smallest, are first united as the new cluster and expressed on the dendrogram.

Subsequently, the controller 11 counts the number of clusters remaining after the clusters are united in step S209 (step S211). The controller 11 then judges whether or not the number of clusters counted in step S211 is one (step S212). For example, in a case where four clusters exist before step S209, because two clusters among the four clusters are united in step S209, the remaining number of clusters is three.

In a case where it is judged that the number of clusters is not one, that is, equal to or larger than two (step S212: No), the processing of the controller 11 proceeds to processing in step S213. The controller 11 then further calculates a difference between clusters united in step S209 and other clusters which are not united (step S213). The controller 11 may, for example, calculate a representative value (center of gravity) of a plurality of feature amounts of the speech included in the united clusters, and may calculate a difference between the representative value and one feature amount of the speech or a difference between the representative values, as the difference between the clusters. The controller 11 then causes the storage 12 to further store the difference calculated in step S211 (step S214). Thereafter, the processing of the controller 11 returns to the processing in step S209, and the processing in steps 5209 to 5214 is repeated until the remaining number of clusters becomes one. That is, the controller 11 executes processing of uniting clusters in ascending order of the difference between the clusters (that is, in descending order of similarity) until the remaining number of clusters becomes one.

In a case where it is judged that the number of clusters is one (step S212: Yes), the controller 11 compares the magnitude of the difference between the clusters (that is, height of similarity) in a predetermined range of the dendrogram (step S215). Here, the predetermined range is a range in which the number of clusters is equal to or larger than two, and is equal to or smaller than the number corresponding to the number of participants confirmed in step S201. For example, in a case where the number of participants is four, the predetermined range is a range in which the number of clusters is equal to or larger than two and equal to or smaller than four. In this case, the controller 11 compares the magnitudes of the differences between the clusters when the clusters are respectively united so that the number of clusters becomes equal to or larger than two and equal to or smaller than four. In the example illustrated in FIG. 7B, magnitudes of differences d1, d2, and d3 between the clusters when the clusters are respectively united so that the number of clusters becomes two to four are compared.

Subsequently, the controller 11 determines the number of clusters existing immediately before the clusters are united in accordance with the largest difference (that is, the lowest similarity) among the differences between the clusters compared in step S215, as the number of speakers (step S216). In the example illustrated in FIG. 7B, because the largest difference among the differences d1, d2 and d3 is the difference d2, and the number of clusters existing immediately before the clusters are united in accordance with the difference d2 is three, the number of speakers is determined as three. That is, the number of speakers is determined within a range which is equal to or larger than two and which does not exceed the number of participants, on the basis of the magnitude of the difference between the clusters.

Subsequently, the controller 11 distinguishes the feature amounts of the speech united in the same cluster, of the number corresponding to the number of speakers determined in step S216 as the feature amounts of the speech of the same speaker (step S217). The controller 11 then distinguishes speakers on the basis of the distinguished result in step S217 (step S218), and the processing returns to the processing in FIG. 3A.

In the example illustrated in FIG. 7C, in a case where the determined number of speakers is three, for example, feature amounts 1, 3, 5 and 10 of the speech among the ten stored feature amounts of the speech are distinguished as the feature amounts of the speech of the same speaker. Further, the feature amounts 2, 4, 8 and 9 of the speech are distinguished as feature amounts of the speech of a speaker different from the speaker of the feature amounts 1, 3, 5 and 10 of the speech. Therefore, the latest feature amount 10 of the speech is distinguished as the feature amount of the speech of a speaker different from the speaker of the feature amount 9 of the speech calculated previously, and the latest speaker is distinguished as a speaker different from the previous speaker. Therefore, in this case, in step S108, it is judged that the speaker changes. Further, the latest feature amount 10 of the speech is distinguished as the feature amount of the speech of the same speaker as that of the feature amounts 1, 3 and 5 of the speech calculated in the past, and the latest speaker is distinguished as the same speaker as the past speaker. Therefore, in this case, in step S111, it is judged that the changed speaker has made statements in the past.

The present embodiment provides the following effects.

The user terminal 10 as the meeting minute output apparatus distinguishes speakers at a meeting on the basis of information regarding the number of participants at the meeting and data regarding speech, and outputs meeting minutes. Because the user terminal 10 distinguishes speakers in accordance with the number of participants, it is possible to distinguish speakers with high accuracy. By this means, the user terminal 10 can output meeting minutes in which speakers at the meeting are distinguished with high accuracy.

Further, the user terminal 10 distinguishes speakers so that the number of speakers does not exceed the number of participants on the basis of the information regarding the number of participants. As a result of the user terminal 10 determining the number of speakers so as not to exceed the number of participants, it is possible to improve accuracy of confirming whether or not the speaker changes.

Further, the user terminal 10 calculates the feature amounts of the speech on the basis of the data regarding the speech and distinguishes speakers on the basis of the calculated feature amounts of the speech. By this means, the user terminal 10 can distinguish speakers without acquiring data regarding the speech from a microphone attached for each speaker or preparing for learning data regarding speech of speakers in advance.

Further, the user terminal 10 classifies the feature amounts of the speech as clusters and determines the number of clusters so as not to exceed the number of participants on the basis of similarity between the clusters. By this means, the user terminal 10 can efficiently determine the number of clusters on the basis of cluster analysis and the number of participants.

Further, the user terminal 10 calculates a difference between clusters using the feature amounts of the speech as clusters. The user terminal 10 then unites the clusters in ascending order of the difference between the clusters (that is, in descending order of similarity), and determines the number of clusters existing before the clusters are united in accordance with the largest difference (the lowest similarity), as the number of speakers. By this means, the user terminal 10 can determine the number of speakers with high accuracy on the basis of cluster analysis.

Further, the user terminal 10 distinguishes the feature amounts of the speech united in the same cluster as the feature amounts of the speech of the same speaker. By this means, the user terminal 10 can distinguish the feature amounts of the speech of the speakers with high accuracy on the basis of the cluster analysis.

Further, the user terminal 10 further judges whether the changed speaker has made statements in the past at the meeting in a case where it is judged that the speaker changes. In a case where it is judged that the changed speaker has not made a statement in the past, the user terminal 10 outputs a label indicating a new speaker, while, in a case where the changed speaker has made a statement in the past, the user terminal 10 outputs a label indicating the corresponding past speaker. By this means, the user terminal 10 can provide an appropriate label in accordance with whether or not the changed speaker has made a statement in the past in a case where the speaker changes.

Further, the user terminal 10 acquires information regarding the number of participants input by the user. By this means, the user terminal 10 can distinguish speakers on the basis of accurate information regarding the number of participants input by the user.

Further, the user terminal 10 distinguishes speakers for each predetermined time period. By this means, the user terminal 10 can promptly and accurately distinguish speakers.

Further, the user terminal 10 acquires information regarding name of speakers corresponding to labels and displays the name of speakers in place of the labels. By this means, the user terminal 10 can output meeting minutes in which the name of the speakers are clearly described.

Further, in a case where a plurality of the same labels are included in the meeting minutes, the user terminal 10 displays the name of the same speaker in place of all the same labels. By this means, the user terminal 10 can effectively reduce time and effort of the user inputting the name of the speakers.

Note that the present invention is not limited to the above-described embodiment, and various kinds of changes, modifications, or the like, are possible within the scope of the claims

For example, in the above-described embodiments, a case has been described as an example where the controller 11 acquires information regarding the number of participants input by the user in step S101. However, the present embodiment is not limited to this. The controller 11 may acquire the information regarding the number of participants using other acquisition methods.

For example, the controller 11 may acquire the information regarding the number of participants on the basis of the notifications transmitted from mobile terminals possessed by participants at the meeting. More specifically, the participants may, for example, possess mobile terminals such as smartphones, which can receive signals of a beacon, or the like, provided at a meeting room, and the controller 11 may receive notifications indicating that the signals of the beacon, or the like, are received, from the mobile terminals The controller 11 may then acquire the information regarding the number of participants which is the number of the received notifications. Alternatively, the controller 11 may receive notifications of device IDs, or the like, of mobile terminals from the mobile terminals located in a predetermined range such as a meeting room using other arbitrary reception methods. By this means, because the user terminal 10 does not have to cause the user to input the number of participants, it is possible to effectively reduce time and effort of the user inputting the number of participants.

Alternatively, the controller 11 may confirm data of the past meeting minutes stored in the storage 12, or the like, and acquire information regarding the number of participants at the past meeting indicated in the past meeting minutes as the information regarding the number of participants in the meeting of this time. The controller 11 may confirm data of the past meeting minutes relating to the meeting minutes of this time, and, for example, may confirm data of the past meeting minutes which has at least one of a title of the meeting minutes, day and time at which the meeting minutes are created, a creator of the meeting minutes, or the like, in common with the meeting minutes of this time. By this means, because the user terminal 10 does not have to cause the user to input the number of participants, it is possible to effectively reduce time and effort of the user inputting the number of participants.

Alternatively, the controller 11 may acquire the information regarding the number of participants on the basis of a situation of call of the number of participants at the meeting. More specifically, the controller 11 may, for example, acquire data regarding speech before the meeting is started, recognize the speech, and acquire information regarding the number of participants called before the meeting is started, the number of participants who respond to the call, or the like. The controller 11 may then confirm the number of participants who are called, the number of participants who respond to the call, or the like, and acquire the information regarding the number of participants. By this means, because the user terminal 10 does not have to cause the user to input the number of participants, it is possible to effectively reduce time and effort of the user inputting the number of participants.

Further, in the above-described embodiment, a case has been described as an example where the controller 11 acquires data regarding the speech input at the speech input 16 in step S103. However, the present embodiment is not limited to this. The controller 11 may, for example, acquire data regarding speech at the past meeting stored in the storage 12, or the like. By this means, even in a case where it is necessary to output the meeting minutes of the past meeting, the user terminal 10 can output the meeting minutes in which speakers at the past meeting are distinguished with high accuracy.

Further, in the above-described embodiment, a case has been described as an example where the controller 11 executes the processing in step S107 for each predetermined time period. However, the present embodiment is not limited to this. The controller 11 may execute the processing in step S107, for example, for each of a predetermined number of statements, that is, every time a predetermined number of statements are accumulated. By this means, the user terminal 10 can distinguish speakers at various timings

Further, in the above-described embodiment, a case has been described as an example where the controller 11 calculates a difference between clusters using each of a plurality of feature amounts of speech as each cluster, and unites the clusters on the basis of the difference between the clusters. However, the present embodiment is not limited to this. The controller 11 may, for example, calculate similarity between clusters defined as an inverse of the difference between the clusters and unite the clusters on the basis of the similarity between the clusters. More specifically, the controller 11 may execute processing of uniting the clusters in descending order of the similarity until the remaining number of clusters becomes one.

Further, in the above-described embodiment, a case has been described as an example where speakers are automatically distinguished. However, the present embodiment is not limited to this. In a case where a wrong label is associated with content of the speech as a label indicating a speaker, the wrong label may be corrected. More specifically, the operation acceptor 15 may accept user operation of correcting a wrong label, and the controller 11 may acquire information regarding correction of a label. Further, the controller 11 may correct a wrong label on the basis of the acquired information regarding correction of the label and cause the display 14 to display the corrected label. Note that the wrong label may be corrected by the user after the meeting ends, or may be corrected by the user every time the wrong label is displayed during the meeting. By this means, even in a case where the user terminal 10 cannot automatically distinguish speakers, the user terminal 10 can cause the user to correct the label, so that it is possible to output meeting minutes in which speakers are distinguished with high accuracy.

Further, in the above-described embodiment, a case has been described as an example where the controller 11 causes the display 14 as an output to output meeting minutes. However, the present embodiment is not limited to this. The controller 11 may cause other arbitrary apparatuses as outputs to output meeting minutes, as an output controller. For example, the controller 11 may transmit data of meeting minutes to other user terminals, a projector, or the like, via a communicator 13, or the like, and cause other user terminals, a projector, or the like, to output the meeting minutes. Alternatively, the controller 11 may transmit data of meeting minutes to an image forming apparatus via the communicator 13, or the like, and cause the image forming apparatus to output the meeting minutes as a printed matter.

### Modified Example 1

In the above-described embodiment, a case has been described as an example where the controller 11 acquires information regarding the number of participants in step S101. In a modified example 1, a case will be described where the controller 11 acquires information regarding the number of participants at different timings.

In a case where the number of participants changes after the meeting is started, the controller 11 acquires information regarding the changed number of participants. A case will be described below as an example where the controller 11 acquires information regarding the changed number of participants input by the user. However, the controller 11 may acquire information regarding the changed number of participants using other acquisition methods as described above.

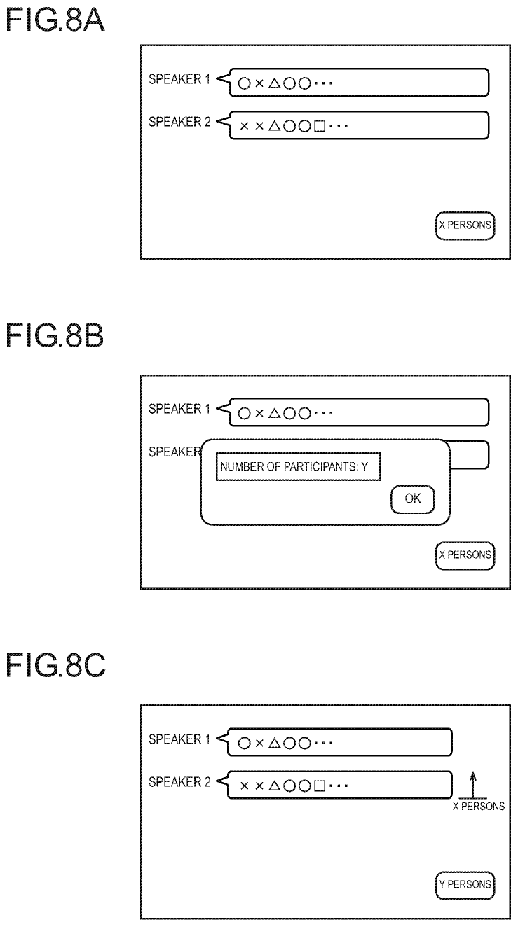

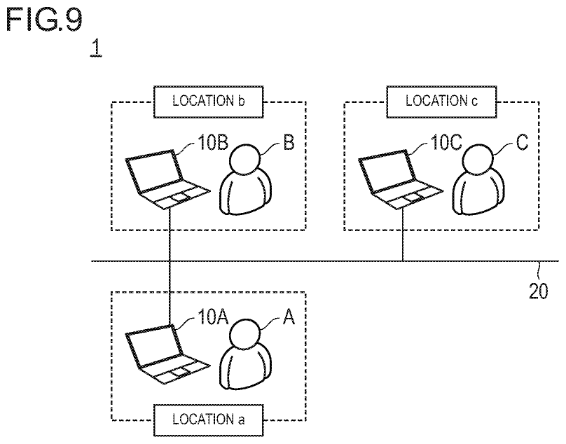

FIG. 8A to FIG. 8C are views illustrating an example of a screen to be displayed at the user terminal.

For example, as illustrated in FIG. 8A, it is assumed that the controller 11 causes the display 14 to display a soft key indicating a current number of participants on the basis of the information regarding the number of participants acquired in step S101. In this situation, in a case where the operation acceptor 15 accepts user operation of depressing the soft key, the controller 11 causes the display 14 to display an input (re-input) screen of the number of participants, for example, as illustrated in FIG. 8B. In a case where the operation acceptor 15 accepts user operation of inputting the changed number of participants, the controller 11 acquires information regarding the changed number of participants input by the user. Further, the controller 11 executes processing in step S107 and subsequent steps on the basis of the acquired information regarding changed number of participants, and distinguishes speakers thereafter. Note that, for example, as illustrated in FIG. 8C, the display 14 may display the number of participants before change, the changed number of participants, and a timing at which the number of participants changes.

As described above, in a case where the number of participants changes after the meeting is started, the user terminal 10 according to the modified example 1 acquires information regarding the changed number of participants and distinguishes speakers thereafter on the basis of the information regarding the changed number of participants. By this means, the user terminal 10 can continue to distinguish speakers with high accuracy even in a case where the number of participants changes during the meeting.

### Modified Example 2

In the above-described embodiment, a case has been described as an example where one user terminal 10 is used at a meeting. In a modified example 2, a case will be described where a plurality of user terminals 10 are used.

FIG. 9 is a view illustrating an overall configuration of a meeting minute output system.

As illustrated in FIG. 9, a meeting minute output (creating) system 1 includes a plurality of user terminals 10A, 10B, and 10C. The plurality of user terminals 10A, 10B, and 10C are located at a plurality of different locations a, b and c, and are used by a plurality of different users A, B, and C. The user terminals 10A, 10B, and 10C have configurations similar to that of the user terminal 10 according to the above-described embodiment, and are connected so as to be able to perform communication with each other via a network 20 such as a LAN (Local Area Network). Note that the meeting minute output system 1 may include components other than the above-described components or does not have to include part of components among the above-described components.

In the modified example 2, one of the user terminals 10A, 10B, and 10C functions as a meeting minute output apparatus. For example, in the example illustrated in FIG. 9, the user terminal 10A may be a meeting minute output apparatus, A may be a creator of the meeting minutes, and B and C may be participants of the meeting. Note that the meeting minute output system 1 is independent of a well-known video conferencing system, a web-conferencing system, or the like, and the user terminal 10A does not acquire information of locations of speakers, or the like, from these systems.

The user terminal 10A as the meeting minute output apparatus executes the processing in steps S101 to S118 described above. However, the user terminal 10A acquires data regarding speech input at the user terminals 10B and 10C from the user terminals 10B and 10C via a network 20, or the like, in step S103. By this means, the user terminal 10A can output meeting minutes in which B and C who are speakers are distinguished with high accuracy in real time.

Further, in the above-described example, A may be a creator of the meeting minutes and a participant in the meeting. In this case, the user terminal 10A acquires data regarding speech input at the own apparatus and also acquires data regarding speech input at the user terminals 10B and 10C in step S103. By this means, the user terminal 10A can output meeting minutes in which A, B, and C who are speakers are distinguished with high accuracy in real time.

Note that the user terminal 10A may acquire data regarding speech acquired at a well-known video conferencing system, a web-conferencing system, or the like, independent of the meeting minute output system 1 from these systems in step S103. By this means, the user terminal 10A can acquire data regarding speech more easily from these systems while realizing high user-friendliness as the meeting minute output apparatus independent of these systems.

As described above, in the meeting minute output system 1 according to the modified example 2, a plurality of different user terminals are used, and data regarding speech is acquired. By this means, in the meeting minute output system 1, in a case where participants in the meeting are located at a plurality of different locations, meeting minutes in which speakers are distinguished with high accuracy are output.

Note that, while, in the above-described embodiment, description has been provided assuming that the user terminal 10 is one apparatus, the present embodiment is not limited to this. For example, an information processing apparatus which executes various kinds of processing and an apparatus which includes a user interface such as a display and an operation acceptor may be separately configured. In this case, respective apparatuses may be connected in a wired or wireless manner. Further, the information processing apparatus which executes various kinds of processing may be a server.

Further, the processing according to the above-described embodiment may include steps other than the above-described steps, or does not have to include part of steps among the above-described steps. Further, order of the steps is not limited to the above-described embodiment. Still further, respective steps may be executed as one step by being combined with other steps, may be included in other steps and executed, or may be divided into a plurality of steps and executed.

Further, it is possible to realize means and methods for performing various kinds of processing at the user terminal 10 according to the above-described embodiment with one of a dedicated hardware circuit and a programmed computer. The above-described program may be provided by, for example, a computer-readable recording medium such as a CD-ROM (Compact Disc Read Only Memory), or may be provided online via a network such as the Internet. In this case, the program recorded in the computer-readable recording medium is normally transferred to a storage such as a hard disk, and stored. Further, the above-described program may be provided as single application software, or may be incorporated into software of the apparatus as one function of the user terminal 10.

Although embodiments of the present invention have been described and illustrated in detail, the disclosed embodiments are made for purpose of illustration and example only and not limitation The scope of the present invention should be interpreted by terms of the appended claims.

What is claimed is:

1. A meeting minute output apparatus comprising a hardware processor that:
acquires information regarding a number of participants at a meeting;
acquires data regarding speech at the meeting;
recognizes the speech on a basis of the data regarding speech and converts the speech into text statements of speakers;
distinguishes the speakers on a basis of the information regarding the number of participants and the data regarding speech; and
causes an output to output meeting minutes in which labels indicating the speakers are associated with content of the statements converted into text.

2. The meeting minute output apparatus according to claim 1, wherein the hardware processor distinguishes the speakers so that a number of the speakers does not exceed the number of participants on a basis of the information regarding the number of participants.

3. The meeting minute output apparatus according to claim 1, wherein the hardware processor calculates feature amounts of the speech on a basis of the data regarding speech and distinguishes the speakers on a basis of the calculated feature amounts of the speech.

4. The meeting minute output apparatus according to claim 3, wherein the hardware processor classifies the feature amounts of the speech as clusters, and determines a number of the clusters so as not to exceed the number of participants on a basis of similarity between the clusters.

5. The meeting minute output apparatus according to claim 4, wherein the hardware processor calculates the similarity, unites the clusters in descending order of the similarity, and determines the number of the clusters existing before the clusters are united in accordance with the lowest similarity, as a number of the speakers.

6. The meeting minute output apparatus according to claim 4, wherein the hardware processor distinguishes the feature amounts of the speech united into the same cluster as the feature amounts of the speech of the same speaker.

7. The meeting minute output apparatus according to claim 1,
wherein the hardware processor judges whether or not the speaker changes on a basis of distinguished results of the speakers, and, in a case where it is judged that the speaker changes, further judges whether or not the changed speaker has made a statement at the meeting in the past,
in a case where it is judged that the changed speaker has not made a statement in the past, the hardware processor causes the output to output the label indicating a new speaker, and
in a case where it is judged that the changed speaker has made a statement in the past, the hardware processor causes the output to output the label indicating the corresponding past speaker.

8. The meeting minute output apparatus according to claim 1, wherein the hardware processor distinguishes the speakers for each predetermined time period or for each of a predetermined number of statements.

9. The meeting minute output apparatus according to claim 1, wherein the hardware processor acquires the input information regarding the number of participants.

10. The meeting minute output apparatus according to claim 1, wherein the hardware processor acquires the information regarding the number of participants on a basis of notifications transmitted from mobile terminals possessed by the participants at the meeting.

11. The meeting minute output apparatus according to claim 1, wherein the hardware processor confirms data of past meeting minutes stored in a storage, and acquires the information regarding the number of participants at the past meeting indicated in the past meeting minutes as the information regarding the number of participants.

12. The meeting minute output apparatus according to claim 1, wherein the hardware processor acquires the information regarding the number of participants on a basis of a situation of call of the participants at the meeting.

13. The meeting minute output apparatus according to claim 1, wherein, in a case where the number of participants changes after the meeting is started, the hardware processor further acquires the information regarding the changed number of participants, and
distinguishes the speakers thereafter on a basis of the information regarding the changed number of participants.

14. The meeting minute output apparatus according to claim 1, wherein, in a case where the label is associated with content of the statement wrongly, the hardware processor further acquires information regarding correction of the label, and
the hardware processor corrects the wrong label on a basis of the information regarding correction of the label and causes the output to output the corrected label.

15. The meeting minute output apparatus according to claim 1, wherein the hardware processor acquires information regarding names of the speakers corresponding to the labels, and
the hardware processor causes the output to output the names of the speakers in place of the labels.

16. The meeting minute output apparatus according to claim 15, wherein, in a case where a plurality of the same labels are included in the meeting minutes, the hardware processor causes the output to output the same name of the speaker in place of all the same labels.

17. A non-transitory recording medium storing a computer readable program
which is a control program of a meeting minute output apparatus which outputs meeting minutes, the control program causing a computer to perform:
acquiring information regarding a number of participants at a meeting;
acquiring data regarding speech at the meeting;
recognizing the speech on a basis of the data regarding speech and converting the speech into text as statements of speakers;
distinguishing the speakers on a basis of the information regarding the number of participants and the data regarding speech; and
causing an output to output meeting minutes in which labels of the distinguished speakers are associated with content of the statements converted into text.

18. The non-transitory recording medium storing a computer readable program which is the control program according to claim 17, wherein, in distinguishing the speakers, the speakers are distinguished so that the number of speakers does not exceed the number of participants on a basis of the information regarding the number of participants.

19. The non-transitory recording medium storing a computer readable program which is the control program according to claim 17, wherein, in distinguishing the speakers, the feature amounts of the speech are calculated on a basis of the data regarding speech, and the speakers are distinguished on a basis of the calculated feature amounts of the speech.

20. The non-transitory recording medium storing a computer readable program which is the control program according to claim 19, wherein, in distinguishing the speakers, the feature amounts of the speech are classified as clusters, and a number of the clusters is determined so as not to exceed the number of participants on a basis of similarity between the clusters.

21. The non-transitory recording medium storing a computer readable program which is the control program according to claim 20, wherein, in the distinguishing the speakers, the similarity is calculated, the clusters are united in descending order of the similarity, and a number of the clusters existing before the clusters are united in accordance with the lowest similarity is determined as the number of speakers.

22. The non-transitory recording medium storing a computer readable program which is the control program according to claim 20, wherein, in the distinguishing the speakers, the feature amounts of the speech united in the same clusters are distinguished as feature amounts of the speech of the same speaker.
